(19) United States
(12) Patent Application Publication
(10) Pub. No.: US 2013/0008030 A1
(43) Pub. Date: Jan. 10, 2013

(54) Electrically Operated Cleaning Device

(76) Inventors: Uwe Fischer, Darmstadt (DE); Norbert Kreutz, Wehrheim (DE); Matthias Wetzel, Schoeneck (DE); Juergen Hoeser, Neu-Anspach (DE)

(21) Appl. No.: 13/537,199

(22) Filed: Jun. 29, 2012

(30) Foreign Application Priority Data
Jul. 6, 2011 (EP) 11005498.8

(51) Int. Cl. A45D 27/46; B08B 3/04

(52) U.S. Cl. 30/41

(57) ABSTRACT

The invention relates to an electrically operated cleaning device for cleaning an electrically operated hair removal apparatus, which comprises a drive means configured in a housing and a cutting or epilation means, which can be driven by the drive means and is arranged on a head end of said housing. For cleaning purposes, the cutting or epilation means can be introduced into a pan which can be filled with a cleaning liquid on the one hand, and which can have the cleaning liquid flowing therethrough on the other hand. According to a first invention, the receptacle is formed directly by the pan, wherein the pan is pivotably mounted on the cleaning device via a rotational axis, wherein an alternating torque acts on the pan for pivoting the same.

### FIELD OF THE INVENTION

The present invention relates to an electrically operated cleaning device.

### BACKGROUND OF THE INVENTION

Electrically operated cleaning devices, such as the one disclosed in DE 199 37 167 C1, are generally known in the art. In DE 199 37 167 C1, a replaceable liquid container is configured in the bottom of a housing, this liquid container in the operating state being in liquid means connection with a pan configured thereabove in the housing via an inlet line and a drain line. Furthermore, an electrically operated pump, which pumps liquid from the tank via the inlet line into the pan when in operation, is configured in the housing.

Projecting into the pan head-first is the shaving head of an electrically operated shaving apparatus, the head being centered in the pan and held in this manner head-first slightly tilted. The shaving head has a slight distance from the wall of the pan, so that when the pan is filled with liquid the shaving head is almost fully immersed in the cleaning liquid. Disposed upwardly adjacent to the shaving head is the housing of the shaving apparatus, in which a drive motor, mechanical transmission means, printed circuit boards and mechanical actuating mechanisms, among other things, are configured. In the case of a rechargeable battery-operated shaving apparatus, a rechargeable battery array can also be configured in the housing.

At the free end of the housing of the shaving apparatus, a contact array is configured which, when the cleaning device is in operation, is in electric contact with a displaceable and lockable contact bridge. Also configured in the housing is a fan array, which blows air into the pan after the shaving head that is provided with a cutting means has undergone cleaning, the air in the process flowing not only around but also through the cutting means via inlets. In this way the cutting means is dried quickly.

The pan is open toward the top and the upper edge thereof extends sufficiently far above the shaving head to enable the same to become completely immersed in the liquid when the pan is filled with liquid. In order to prevent the liquid from splashing out over the edge of the pan, a level sensor is configured on the edge of the pan, the sensor emitting an electrical signal to the switching means when the liquid has reached the maximum fill level thereof in the pan. This causes the pump to switch off. The pump can, of course, also be controlled by a time-dependent control means, for which the delivery rate per time unit that is required for filling the pan must be known.

The shaver is centered on one side in the pan via guiding elements configured therein, and on the other side on the housing via the contact array and the contact bridge, wherein the contact bridge centrically engages with the recess of the contact array of the shaving apparatus while in operation.

Since too much liquid is present in the entire cutting means after a cleaning process for reasons that are related to the design, a conventional drying process takes a relatively long time.

Furthermore a manually operated cleaning device for the shaving head of an electrically operated shaving apparatus is known from DE 103 15 451 A1, in which the shaving apparatus is held vertically over a pan via a holding device. For cleaning, the holding device is pushed against the force of a spring in the direction of the pan until the cutting means immerses into the cleaning liquid. In the immersed position of the shaving head, a detent element then snaps in at a hook on the housing, whereby the shaving head now remains in the immersed position. The cleaning process can now begin by pumping cleaning liquid from a tank into the pan and back via a reciprocating pump. After the cleaning process, the detent means is released and the force of the spring causes the holding device to return into the initial position thereof together with the shaving apparatus.

No provision is made in this arrangement for a drying process that incorporates a fan; instead the shaver is left out in the air until the highly volatile cleaning liquid on the cutting means has evaporated or volatilized.

A cleaning device for the shaving head of a dry shaving apparatus is likewise known from DE 10 2004 032 518 A1, in which a transversal bolt engages with a bottom wall situated opposite of the housing after the shaving head, which is provided with a cutting means, is introduced into a pan, and the pivotable shaving head with the cutting means thereof is thereby secured in place in the pan. In this embodiment a U-shaped heating unit is configured below the pan, the unit, during a drying process, heating the pan and, because of the acting radiant heat, therefore also heating the cutting head together with the cutting means thereof, whereby the drying process is accelerated.

Lastly, an automatic cleaning device for an electrically operated shaving apparatus is also known from EP 1 788 904 B1, in which a pan contains a cleaning liquid at all times. In the initial state, the pan is closed by a cover configured with a valve means. The cover has a centering means for receiving a cutting head of a shaving apparatus, the cutting head being provided with a cutting means. The housing of the shaving apparatus is accommodated and held in a receptacle, which can be moved into a raised or lowered position by way of an electrically operated gearwheel adjustment.

On lowering, the cover is displaced in the pan such that a stop configured in the bottom of the pan opens the valve means and liquid travels to the upper face of the cover through the valve opening and in this manner fills an upper chamber. This process is continued until the cutting means of the shaving apparatus is completely immersed in the cleaning liquid. Now the cutters of the cutting means are set into motion via an electric control unit, such that the liquid flows around the cutting means and adhering debris is removed and entrained in the liquid in the process. Following the cleaning process, the mechanical actuating means of the lifting device, and therefore also the shaving apparatus, is moved upward, again via the electric drive. In the process the cutting means and the cover re-emerge upward from the cleaning liquid, and the cutting means can be dried via an electrically operated drying device integrated in the cleaning device. In this arrangement as well, the cleaning liquid remains standing over the entire surface area of the cutting means prior to the drying process, which leads to a relatively long drying process and also entails an increased consumption of cleaning liquid.

### SUMMARY OF THE INVENTION

It is the object of the invention to create an electrically operated cleaning device for an electric hair removal apparatus, preferably for a shaving apparatus or an epilation means, by means of which improved and more thorough cleaning and also a shorter and more thorough drying process are made possible.

This object is achieved according to the invention in that the receptacle is formed directly by the pan, the pan is pivotably mounted on the cleaning device about a rotational axis, and an alternating torque acts on the pan for pivoting the same. Owing to the back-and-forth pivoting of the pan, and accordingly also owing to the alternating movement of the hair removal apparatus, the cleaning liquid present in the pan is set into motion, so that the cleaning liquid can flow better through or around the shaver head or epilation head present therein. The hair removal apparatus moves simultaneously with the pan; however, because of the inertia of the liquid, the liquid is set into a back and forth movement, thus making possible an improved flow of same through the cutting or epilation means. This can also be intensified by exerting an oscillating torque on the pan. Not so vigorously though as to cause the cleaning liquid to splash out of the pan. The oscillating motion can be so short-stroked for this purpose that the cleaning liquid produces very minute back and forth movements, which enable intensive cleaning of the cutting or epilation means

According to an embodiment of the invention, the pan is connected to a liquid container via flexible tubes, the container supplying cleaning liquid to the pan via an electric pumping means. Because flexible tubes are used from the pan to the liquid container, liquid can be pumped into the pan, and also out of the pan back into the liquid container, at all times during the pivoting operation without impairing the pivoting action of the pan.

In one embodiment, a lever engages with the pivot axis of the pan, the lever being connected to an electrically operated actuating means for the purpose of generating the torque. The electrically operated actuating means can be formed, for example, by a linear motor, a pneumatic-hydraulic device, or also by a disk cam mechanism having an electric drive, wherein the actuating means is always arranged such that it exerts a force that acts on the pan outside of the pivot axis for generating a torque. The movement of the pan can be adjusted by varying and reversing the polarity of the motor current or motor voltage. According to this measure, the pan can be accelerated or decelerated either more or less.

The pivot axis of the pan generally advantageously extends perpendicular or slightly obliquely to the longitudinal axis of the hair removal apparatus, that is to say, the longitudinal axis of the hair removal apparatus is defined by the longitudinal extension of the housing thereof and the adjoining cutting or epilation means, which extends head-first into the pan and is accommodated therein in a centering manner. The rotational axis advantageously extends substantially parallel to the surface of the cleaning liquid; however it can also extend slightly inclined upward or downward relative to the surface. The longitudinal axis of the hair removal apparatus can accordingly extend perpendicularly to the surface of the cleaning liquid, or obliquely thereto at a predefined angle, as will be shown, among other things, in one of the embodiments.

If the cleaning liquid has been suctioned or removed from the pan after a cleaning process, the drying process can also be shortened and improved if the actuating means now pivots the pan such that the liquid still present in the interior and along the outer edge of the cutting or epilation means drains off to one side or corner, where it drips down and flows back into the liquid container. In this manner, less liquid needs to evaporate, thereby increasing the useful life of the cleaning liquid. Moreover, this considerably shortens the drying time.

In another embodiment, the pan is no longer pivotably arranged in the cleaning device—because the same is now secured in a stationary manner in the housing—and instead a receptacle accommodating the hair removal apparatus assumes the holding function and provides the pivoting movement. In this arrangement, a receptacle that is arranged separately pivotably on the housing projects into the pan, wherein this receptacle accommodates the hair removal apparatus with the head of the receptacle down. To this end, the receptacle is pivotably mounted on the cleaning device about a pivot axis such that the hair removal apparatus accommodated and supported by the receptacle projects with the cutting or epilation means thereof into the pan and immerses into the cleaning liquid when the pan is filled with the same.

During a drying process, cleaning liquid dripping down from the cutting or epilation means falls into the bottom of the pan and is guided to the outlet of the pan. The pivotable arrangement of the receptacle can thus serve, on the one hand, to achieve improved cleaning of the cutting or epilation means during the cleaning process, however, on the other hand it is also possible to achieve faster drying after the cleaning of the cutting or epilation means by pivoting the receptacle so that the cleaning liquid present in or on the cutting or epilation means drains off to a side or corner that has the smallest surface area of a shaving head or epilation head. During the cleaning process, the receptacle can be moved rapidly back and forth in an oscillating manner such that the cleaning liquid flows through the cutting or epilation means at a relatively high speed in alternating directions and in the process entrains dirt particles adhering to the shaving or epilation means and transports them into the refill pan, where they will settle to the bottom.

In one embodiment, it is particularly advantageous that the rotational axis for the receptacle is configured on the pan. The pan serves as a support for the receptacle, since it is already arranged in a stationary manner in the housing of the cleaning device.

In one embodiment, the rotational axis is formed by a bearing journal configured on the pan, the bearing journal passing through a bore provided on the receptacle, being guided and sealed in the bore and connected in a rotationally fixed manner to a lever, which, in turn, away from the bearing point is connected to an electro-mechanical actuating device. An electro-mechanical actuating device of this type is particularly easy to implement can pivot the lever and therefore the receptacle back and forth with respect to the pan within a pivoting range that can be as large as desired, within certain limits.

In one embodiment, the pivot axis extends substantially transversely to the longitudinal axis of the hair removal apparatus. The longitudinal axis of a hair removal apparatus is defined by this axis extending centrically and symmetrically to the hair removal apparatus. However, other angular positions are also possible; of importance in this context is always that one side of the cutting or epilation means is closer to the bottom of the pan during pivoting than the other side of this cutting or epilation means, so as to allow the liquid to be able to drain off better to a narrow side during the drying process, for example. During a cleaning process with the cutting or epilation means immersed into the cleaning liquid, the size of the pivot angle is of lesser significance; of importance in this context is only that a rapid oscillating pivoting motion sets the cleaning liquid into a pronounced back and forth movement, so that the cleaning liquid therefore readily flows through the cutting or epilation means and the same is therefore cleaned very thoroughly.

In one embodiment, the electro-mechanical actuating device preferably comprises an electric motor having a drive shaft, wherein the drive shaft is connected to a threaded spindle engaged with a threaded nut. To this end, the nut is connected to the lever at a distance from the mounting thereof. In this manner, a threaded spindle drive is created, which moves the lever and therefore the receptacle back and forth either faster or more slowly according to the pitch of the thread and rotational speed of the electric motor. The rotational speed of the motor can be adjusted by varying the motor current and also via the motor voltage (acceleration, deceleration).

Other drive means that are common to a mechanical engineer can, of course, be selected in lieu of a spindle drive, such as the use of a linear motor or a pneumatic-hydraulic device and, lastly, also a drive in which an eccentric on a motor axis drives the lever directly (disk cam mechanism).

According to the invention, the pivotable arrangement of the pan can be used both for improved cleaning of the epilation or cutting means of a hair removal apparatus and for faster drying thereof. It is also conceivable, however, to combine the two applications, so that the pan is moved in an oscillating manner, and hence the hair removal apparatus is moved in the pan, during the cleaning operation, and after cleaning the receptacle is pivoted such that the cleaning liquid present in the cutting or epilation means drains off to one side.

If the invention is used only for the purpose of faster cleaning, a memory element or even a thermocouple would suffice as a drive, because all that is required in this arrangement during a drying process is that the lever be actuated once in one direction after brief heating, then comes to a stop and subsequently, during cooling, returns to the initial position thereof.

In order for the rotary spindle to be able to follow the rotary movement of the lever at the point of contact of the lever, in one embodiment, the nut connected to the rotary spindle is fixed in a bore configured on the lever. In order for the threaded spindle to be mounted stress-free between the nut and the electric motor, without bending stresses occurring in the spindle because of the rotary movement at the lever, according to another embodiment, the electric motor is fastened on a bearing axis that extends parallel to the center axis (43) of the threaded nut (44). Additionally, according to another embodiment, the electric motor is elastically mounted on a bearing bracket fixed to the housing. In lieu of the elastic mounting, it is also possible, of course, to use a spherical mounting, so as to allow the electric motor to follow the up and down movements of the threaded spindle in this arrangement as well. Here too, many other mounting options are conceivable which, for the sake of simplicity, will not be addressed here.

In order to be able to insert the hair removal apparatus into the receptacle as quickly as possible, while at the same time ensuring that it is held securely in the receptacle, according to another embodiment at least one support element and at least one magnet spaced apart therefrom are configured in the receptacle, the magnet holding the hair removal apparatus, when inserted, in the receptacle so that the acting pivot movements do not cause the hair removal apparatus to fall out nor slide back and forth. For this purpose, additional lateral wall surfaces are provided on the receptacle, which are used to securely hold the hair removal apparatus in the receptacle.

According to another embodiment, electrical contacts are configured on the receptacle, which are connected via electrical leads to the electric circuit of the cleaning device and via mating electrical contacts to the hair removal apparatus when the latter is inserted in the receptacle. As a result, the hair removal apparatus is supplied with electric energy and can also be controlled appropriately during the cleaning process. The electrical leads to the circuit are designed to be flexible, so as to be able to compensate for the movements of the receptacle during the cleaning operation.

### BRIEF DESCRIPTION OF THE DRAWINGS

Each of the two inventions is illustrated by one embodiment shown in the drawings and will be explained in greater detail below. The drawings show as follows:

FIG. 1 shows a highly schematic sectional view at an enlarged scale of the upper region of a cleaning device in which the pan is pivotably mounted about a rotational axis,

FIG. 2 shows a highly schematic illustration according to view X according to FIG. 1, however, in this case with only the general mounting of the pan shown at a reduced scale compared to FIG. 1,

FIG. 3 shows a view of the rear of a shaving apparatus in a vertical initial position, the shaver being inserted in a receptacle of the cleaning device according to the invention, with the upper part of the housing of the cleaning device being removed in order to be able to see the actuating device configured in the interior,

FIG. 4 shows an illustration according to FIG. 3, however, here with the pan having been deflected into the maximum pivot position thereof in a clockwise direction about the rotational axis during the drying process,

FIG. 5 shows a section according to line Y-Y of FIG. 3 through the pan and through the lever with the actuating device thereof, however here without the shaving apparatus having been inserted into the receptacle,

FIG. 6 shows a median section of part of the cleaning device according to FIG. 5, however here with a shaver being inserted in the receptacle, albeit shown only in parts, and with portions of a cleaning container visible below a base plate, as compared to FIG. 5.

### DETAILED DESCRIPTION OF THE INVENTION

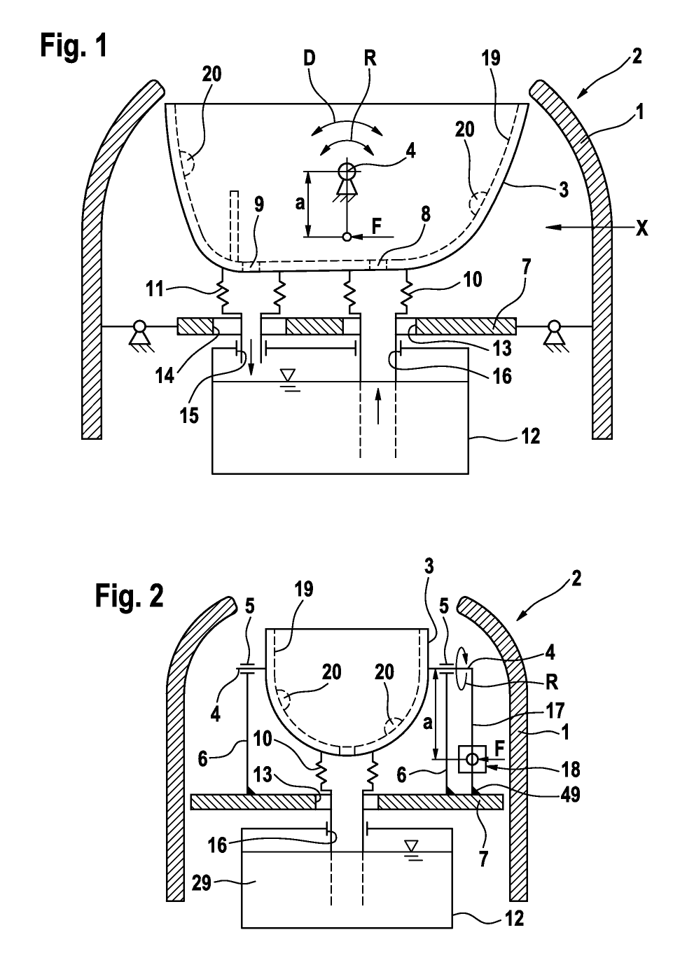

FIGS. 1 and 2 show only highly schematically a pan 3 that is open toward the top and configured in an upper housing shell 1 of a cleaning device 2, the pan at the same time serving as a receptacle for a hair removal apparatus, which is not shown in the drawing, preferably an electrically operated dry or wet shaving apparatus. The pan 3 according to FIG. 2 is pivotably mounted on a rotational axis 4 clockwise and counterclockwise in the pivoting direction R, the rotational axis 4 preferably acting on the pan 3 on both sides and extending substantially horizontally according to FIG. 2. The rotational axis 4 of the pan 3 is mounted on both sides of the pan 3 in bearing shells 5 made preferably of plastic, wherein the bearing shells 5 are mounted on a base plate 7 via bearing brackets 6 in a stationary manner.

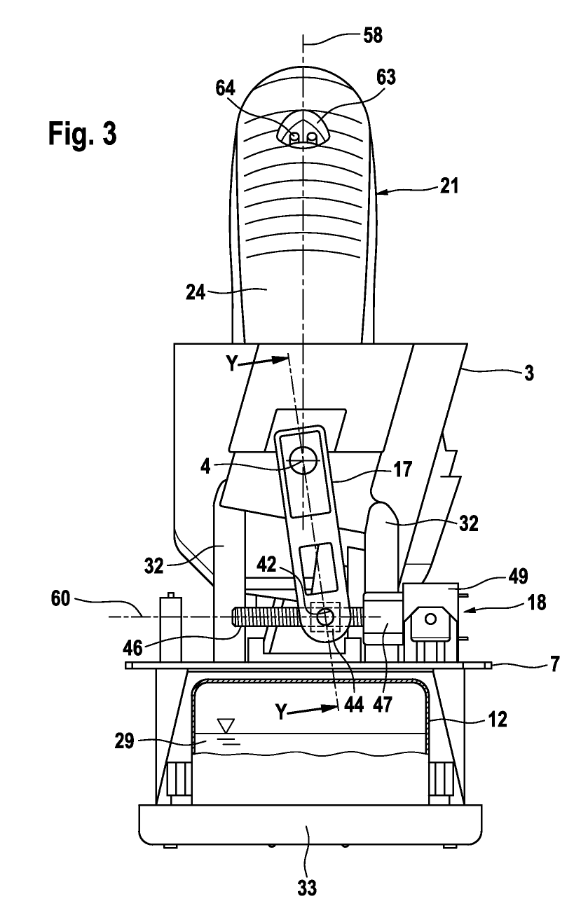

On the bottom, the pan 3 has an inlet 8, and at the lowest point thereof it has an outlet 9, the inlet and outlet being sealingly connected to a cleaning container 12, also referred to as a cleaning liquid reservoir, configured below the base plate via a flexible tube connection 10, 11. The tube connections 10, 11 pass through bores 13, 14 configured in the base plate 7 and open in a liquid-tight manner into an outlet 16 or inlet 15 configured on the cleaning container 12. According to FIG. 2, the rotational axis 4 is connected to a mechanically-electrically actuatable actuating device 18 via a downwardly extending lever 17, with the actuating device, however, being is shown more clearly in FIGS. 3 to 6 and intended to also be the subject matter of FIGS. 1 and 2. The actuating device and operating principle thereof will therefore not be discussed in detail here, but will be explained in detail based on FIGS. 3 to 6.

On the inside wall 19 of the pan 3, according to FIGS. 1 and 2 spacer elements 20 are configured in the form of elastic nubs, which upon insertion of a hair removal apparatus hold the same at a uniform distance with respect to the inside wall 19 and at the same time provide the hair removal apparatus (not shown in FIGS. 1 and 2) with a secure, non-slip hold in the pan 3.

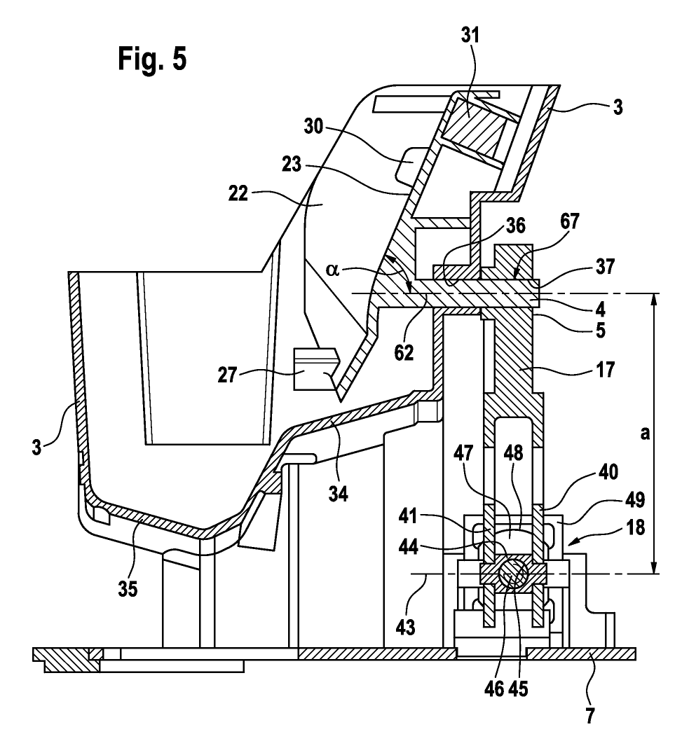

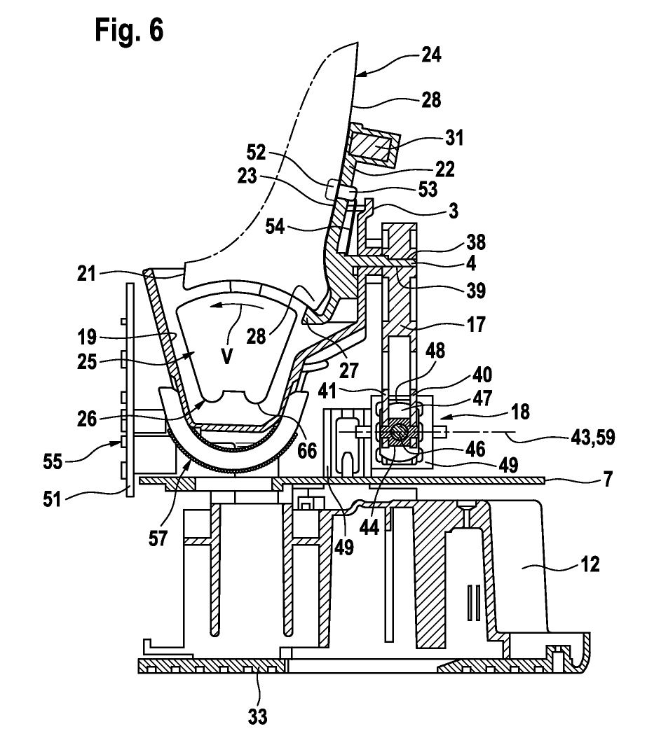

FIGS. 3 to 6 also show only parts of the cleaning device 2, wherein all position numbers indicated in FIGS. 1 and 2 are also used here for correspondingly identical components, so that, for the sake of simplicity, these will not need to be explained again. The cleaning device 2 differs from the cleaning device according to FIGS. 1 and 2 substantially in that the hair removal apparatus, which here is an electrically operated shaving apparatus 21, is no longer supported directly by the pan 3 but instead by a separate component, which here is formed by a receptacle 22 (FIGS. 5 and 6). The receptacle 22 according to FIGS. 5 and 6 comprises a shell that is open toward the left, against the inside wall 23 of which the rear 24 and in part the two lateral surfaces of the shaving apparatus 21 are leaned.

When a shaving apparatus 21 according to FIGS. 5 and 6 is inserted into the receptacle 22, the pivoting head 25, which is configured at the head end of the shaving apparatus 21 and in which a cutting means 26 is configured, is pivoted in the direction of the arrow V such that a support element 27 protruding on the lower region of the inside wall 23 of the receptacle 22 latches over the housing wall 28 of the shaving apparatus 21. In this manner, the shaving apparatus 21 is literally suspended on the receptacle 22. In order for the shaving apparatus 21 to be provided with absolutely secure and fixed hold in the shell-shaped receptacle 22, a magnet 31 is additionally fastened to the upper region of the receptacle 22, the magnetic force of the magnet holding the upper region of the shaving apparatus 21 in contact with the inside wall 23 of the receptacle 22 at all times. For this purpose, of course, iron elements are fastened in or to the housing wall 28 of the shaving apparatus 22, which, however, are not shown in any greater detail here. According to FIG. 5, inwardly projecting delimiting elements 30 are configured on both sides on the upper region of the inside wall 23, which also provide the shaving apparatus 21 with lateral support. When in the cleaning position, the shaving apparatus 21 is held in the receptacle 22 such that the pivoting head 25 has a sufficiently large distance to the inside wall 19 of the pan 3 so as to enable the cleaning liquid 29 that flows into and out of the pan 3 to readily flow around the pivoting head 25. This purpose is served by spacer elements 20, such as those indicated in FIGS. 1 and 2.

Specific details of the shaving apparatus 21 will not be explained in detail here, because a cleaning device comprising a shaving apparatus has already been sold by the applicant for many years, including, for example, the Braun Syncro “smart logic” 7000 Series, or the Braun Pro Sonic 9595 Series shaver.

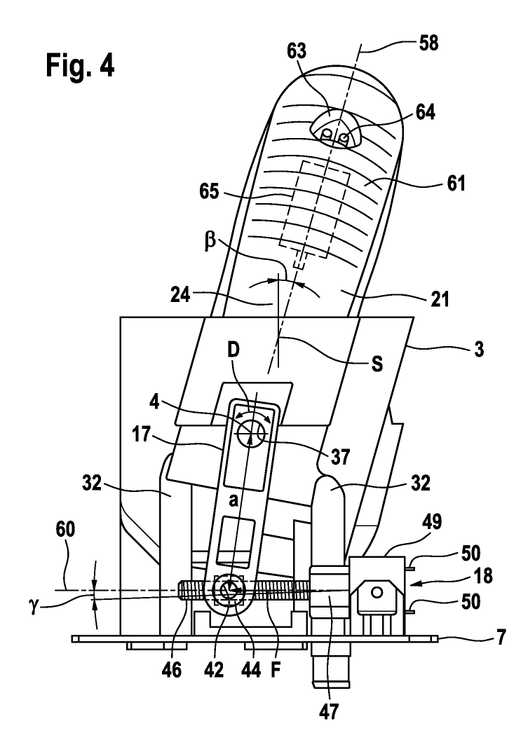

According to FIGS. 3 and 4, the pan 3 is fixedly mounted via supports 32 on the base plate 7; however, the supports 32 can also pass through the plate 7 and be fastened to a bottom plate 33 that accommodates the cleaning container 2 or they can be designed to be integral with said bottom plate in the form of an injection-molded part made of a plastic material. In FIGS. 4 and 5 only the partial section above the base plate 7 of the cleaning device 2 is shown in part, again with the housing of the cleaning device 2 that surrounds the pan 3 and the receptacle 22 not shown.

The receptacle 22 according to FIGS. 5 and 6 extends slightly obliquely from the top right to the bottom left into the pan 3 and ends slightly above a stepped wall 34, downwardly adjoining which is another recessed bottom region 35, at the lowest point of which the outlet 9 (FIG. 1) to the cleaning container 12 is configured. In the lower region, the rotational axis 4, which is integrally molded with the receptacle 22 preferably from a plastic material, extends away from the receptacle 22 in a transversal direction. The rotational axis 4 passes to the outside through a bore 36 configured in the pan 3. The rotational axis 4 is formed by a shaft that is guided and supported with precise fit and in a sealing manner in the bore 36. According to FIG. 5, the rotational axis 4 extends horizontally, wherein the inside wall 23 extends thereo at an angle α from 45° to maximally 90°. This prevents the shaving apparatus 21 from falling out too easily during a cleaning process.

On the section 67 of the rotational axis 4 that projects out of the pan 3, the lever 17 is shrunk-on in a rotationally fixed manner via a fitted bore 37 configured on the lever 17 and is mounted on the pan 3 in this manner. The press-fit connection can, of course, also be substituted by a polyhedral toothing, a locking groove, or by some other rotationally fixed connection, such as gluing, welding, or the like. In FIG. 6, for example, a flattened region 38, which is in rotationally fixed engagement with a fitted bore 39 adapted thereto, is configured at the free end of the rotational axis 4.

According to FIGS. 5 and 6, the section of the lever 17 that is situated opposite of the fitted bore 37 forms two fork ends 40, 41, which extend parallel to one another and each have a bore 42 configured at the end. The bores 42 are aligned with one another and form a common central axis 43, which extends parallel to the central axis 62 of the rotational axis 4. Passing through both bores 42 is a threaded nut 44, which is configured as a dowel pin and mounted rotatably and with a precise fit in the bores 42 and is held in the bores, for example from the outside and/or inside, by means of circlips (Seeger circlip rings, not shown) in a stationary yet rotatable manner

According to FIGS. 3 and 4, a centrally arranged continuous threaded bore 45, which is in threaded engagement with a threaded spindle 46, is configured between the fork ends 40, 41 in the threaded nut 44 perpendicular to the central axis 43. The motor end of the threaded spindle 46 is connected in a rotationally fixed manner to a drive shaft (not shown) of an electric motor 47 (FIG. 5), wherein the electric motor 47, together with the housing thereof, is pivotably mounted in a spherical bearing 48 (FIGS. 5 and 6), so that the central axis 60 of the threaded spindle 46 according to FIG. 4 can pivot downward by the angle γ. The spherical bearing 48 is configured in a bearing bracket 49 that is fastened to the base plate 7. The spherical bearing 48 forms a bearing axis (59) that extends parallel to the central axis 43 of the threaded nut 44 but, according to FIG. 6, coincides with the central axis 43 when the lever 17 is in the initial position. Contact tags 50 indicated in the drawing connect the electric motor 47 via leads, which are not shown, to a printed circuit board 51 shown only in FIG. 6 of the drawings, which is likewise fastened to the base plate 7.

In the cleaning operation, the electric components 55 fastened to the printed circuit board 51 according to FIG. 6 control both the cleaning device 2 and the shaving apparatus. The printed circuit board 51 is connected to an electric power supply unit via electrical leads (not shown). Furthermore, when the shaving apparatus 21 is inserted, it can be connected via electrical switching contacts 52 to matching switching contacts 53, which according to the embodiment shown in FIGS. 1 and 2 are configured on the pivotable pan 3 and according to the embodiment shown in FIGS. 3 to 6 are configured on the pivotably mounted receptacle 22. The switching contacts 53 configured on the receptacle 22 are connected to the electrical components 55 on the printed circuit board 51 via flexible electrical leads 54. According to FIG. 6, the pan 3 is surrounded in part from the outside in the lowest region thereof by a U-shaped heating unit 57 so as to accelerate the drying process on the cutting means 26 and on the pivoting head 25 at the end of a cleaning process.

As is apparent from FIG. 4 compared with FIG. 3, the shaving apparatus 21 has been pivoted clockwise about the angle β, which ranges between 35° and 5°, preferably 15°. From FIG. 4 it is also apparent that the rotational axis 4 is situated below the center of gravity S of the shaving apparatus 21. However, the inertia forces acting on the receptacle 22 while the shaving apparatus 21 is pivoted back and forth would have virtually no effect on the rotational axis if the center of gravity S of the shaving apparatus 21 were located approximately at the height of the rotational axis 4. The center of gravity S of the shaving apparatus 21 furthermore is approximately on the longitudinal axis 58 of the shaving apparatus 21.

According to FIGS. 3 and 4, on the rear 24 of the shaving apparatus 21 a depression 63 is provided, in which electrical contacts 64 are configured for connecting a plug of a power cable (not shown) so as to permit a normal shaving operation when no cleaning device is used and when the apparatus is also not equipped with rechargeable batteries.

The operating principle of the cleaning device according to the invention according to FIGS. 1 and 2 is as follows:

After cleaning liquid 29 has been delivered by a pumping system (not shown) from the cleaning container 12 (FIG. 3) into the pan 3 via the tube connection 10 during a cleaning process, electric power is supplied via the electric switching contacts 52, 53 (FIG. 6) to the drive means 65 (only outlined) of the shaving apparatus 21, such that the cutting means 26 is set in motion by the drive means 65. As a result, owing to the perforated foil 66 or owing to inlets (not shown) in the pivoting head 25, cleaning liquid 29 flows around and through the cutting means 26 and dirt particles are dislodged and become incorporated with the cleaning liquid 29.

For further improved cleaning, the electric motor 47 of the actuating device 18 can now be set into rotation, causing the threaded spindle 46 to start to rotate and the threaded nut 44, which is pivotably mounted in the lever 17, to now move away from the electric motor 47 because of the stationary position of the electric motor 47, so that after a certain on-period the oblique position of the pan 3 shown in FIG. 4 (angle β) and of the shaving apparatus 21 accommodated therein is effected. The torque introduced in the pan 3 in the process results from the spindle force F times the lever arm a. By reversing the sense of rotation of the electric motor 47, which can be effected by a polarity reversal, the lever 17 moves back into the initial position thereof FIG. to FIG. 3 about the pivot axis 4, such that the pan 3 and therefore the shaving apparatus 21 are also returned into the initial position thereof according to FIG. 3.

Depending on how rapidly this movement according to the first invention is performed in an oscillating on the pan 3, the more readily the cleaning liquid 29 flows through the pivoting head 25 as a result, and the better the cleaning action. In addition, the cutting means 26 of the shaving apparatus 21 can also be set into an oscillatory motion in the cleaning liquid, and the cleaning liquid 29 can also be kept in a flowing motion in the pan 3 by the pumping system, in order to achieve even more thorough and faster cleaning

After the end of a cleaning process, after the cleaning liquid 29 has flown back from the pan 3 via the tube connection 11 into the cleaning container 12, the pan 3 and hence the shaving apparatus 21 can be returned into the oblique position shown in FIG. 4 by again switching on the electric motor 47, so that the cleaning liquid 29 present in the pivoting head 25 can drain off as quickly as possible to a narrow side or even to a corner, thereby shortening the drying process.

The operating principle of the cleaning device according to the second invention according to FIGS. 3 to 6 substantially corresponds to the operating principle of the cleaning device according to FIGS. 1 and 2. The only difference is that here the pan 3 is no longer pivotable but instead is fixedly fastened to the base plate 7 or to the bottom plate 33 and the shaving apparatus 21 is now held in a receptacle 22 that projects into the pan 3 and is pivotably supported on the pan 3.

On actuation of the actuating device 18, the rotational axis 4 and therefore also the receptacle 22 are now pivoted clockwise when the lever 17 is pivoted, so that the shaving apparatus 21 assumes the oblique position shown in FIG. 4. Here, too, the torque D resulting from the force F that is introduced in the threaded nut 44 times the lever arm a is introduced into the receptacle. Because of the rotary movement of the lever 17, the threaded nut 44 has also turned slightly in the bore 42, a movement which due to the movement geometry was likewise performed by the electric motor 47 in the spherical bearing 48 thereof. During the return movement, the receptacle 22 is pivoted back into the approximately vertical position shown in FIG. 3. Here, too, the actuating device 18 can be moved back and forth in such a quickly pulsating manner during the cleaning process that the cleaning liquid flows around or through the pivoting head 25 in an accelerated manner and improved cleaning is thus achieved.

After completion of the cleaning process, during the drying process the receptacle 22 can be moved into the oblique position (angle β) shown in FIG. 4 by means of the actuating device 18 and remain in this position until the liquid has drained from the pivoting head 25 to one side or corner and the pivoting head has then dried completely. The receptacle 22 and therefore the shaving apparatus 21 are then returned into the vertical initial position thereof shown in FIG. 3, again by actuating the actuating device 18.

The arrays according to the inventions can be used either only in the drying process or during the cleaning process or in both processes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electrically operated cleaning device for cleaning an electrically operated hair removal apparatus, said hair removal apparatus comprising a housing having a head end, a drive means configured in the housing, and a cutting or epilation means which can be driven by the drive means and is arranged on the head end of the housing;
wherein the cleaning device comprises:
a) a housing,
b) a pan, which has a rotational axis and into which the cutting or epilation means can be introduced for cleaning purposes, and which can be filled with a cleaning liquid and which can have the cleaning liquid flowing therethrough,
c) a receptacle, onto which the hair removal apparatus is mountable head-first, and
d) a means for generating an alternating torque;
wherein the receptacle is formed directly by the pan, the pan is pivotably mounted on both sides on the cleaning device via the rotational axis, and the alternating torque acts on the pan for pivoting the same.

2. The cleaning device according to claim 1, further comprising a liquid container, flexible tubes, and an electrically operated pumping means and in that the pan is connected to the liquid container via the flexible tubes, the liquid container supplying cleaning liquid to the pan via the electrically operated pumping means.

3. The cleaning device according to claim 1, further comprising a lever and an electrically operated actuating device and in that the lever acts on the rotational axis of the pan, the lever being connected to the electrically operated actuating device for generating the alternating torque.

4. The cleaning device according to claim 1, wherein the pan is pivotably mounted on both sides of the housing of the cleaning device.

5. The cleaning device according to claim 4, wherein the rotational axis extends substantially transversely to the longitudinal axis of the hair removal apparatus.

6. An electrically operated cleaning device for cleaning an electrically operated hair removal apparatus, said hair removal apparatus comprising a housing having a head end, a drive means configured in the housing, a cutting or epilation means which can be driven by the drive means and is arranged on the head end of the housing;
wherein the cleaning device comprises:
a) a housing,
b) a pan which has a rotational axis and into which the cutting or epilation means can be introduced for cleaning purposes, and which can be filled with a cleaning liquid, and which can have the cleaning liquid flowing therethrough,
c) a receptacle, onto which the hair removal apparatus is mountable head-first, and
d) a means for generating an alternating torque;
wherein the receptacle is formed by a separate component and that the receptacle is pivotably mounted on the cleaning device about a pivot axis.

7. The cleaning device according to claim 6, wherein the rotational axis is configured on the receptacle, which engages with the pan.

8. The cleaning device according to claim 7, wherein it comprises an electro-mechanical actuation device and in that the rotational axis is formed by a bearing journal projecting from the outside wall of the pan, the bearing journal passes through a bore provided on the pan, the bearing journal is guided and sealed in the bore, and the bearing journal is connected in a rotationally fixed manner to a lever which, in turn, away from the rotational axis is connected to the electro-mechanical actuation device.

9. The cleaning device according to claim 8, wherein the rotational axis extends substantially transversely to the longitudinal axis of the hair removal apparatus.

10. The cleaning device according to claim 8, further comprising a threaded nut and the electro-mechanical actuation device comprises an electric motor having a threaded spindle, which threaded spindle being in engagement with the threaded nut, and in that the threaded nut is connected to the lever at a distance from the rotational axis of the lever.

11. The cleaning device according to claim 10, wherein the threaded nut is rotatably fixed in a bore on the lever.

12. The cleaning device according to claim 10, further comprising a bearing axis and in that the electric motor is fastened to the bearing axis which extends parallel to the central axis of the threaded nut.

13. The cleaning device according to claim 10, further comprising a breaking bracket and in that the electric motor is elastically mounted on the bearing bracket fixed on the housing.

14. The cleaning device according to claim 6, further comprising at least one support element and at least on magnet and in that the least one support element and the at least one magnet spaced apart therefrom are configured in the receptacle.

15. The cleaning device according to claim 14, wherein, upon use for cleaning an electrically operated hair removal apparatus, through which magnet the hair removal apparatus, when inserted, is drawn toward the magnet such that, on the one hand, the weight of the hair removal apparatus is supported on the support element, and on the other hand a rear wall rests against the inside wall of the receptacle in a stationary manner

16. The cleaning device according to claim 6, wherein electrical contacts are configured on the receptacle, the electric contacts being connected via electrical leads to the electric circuit of the cleaning device on the one hand, and on the other hand the electric contacts, upon use, being suitable for establishing the electric contact to the hair removal device, when inserted, such way that corresponding electrical switching contacts can protrude from the hair removal apparatus, which can enter into contact with the electrical contacts.
